(19) United States
(12) Patent Application Publication
(10) Pub. No.: US 2026/0132005 A1
(43) Pub. Date: May 14, 2026

(54) DATA TRANSMISSION DEVICE FOR A LIFTING PLATFORM

(71) Applicant: MAHA Maschinenbau Haldenwang GmbH & Co. KG, Haldenwang (DE)

(72) Inventors: Benjamin FÜRHAUPTER, Altusried (DE); Thomas FELDMEIER, Altusried (DE)

(21) Appl. No.: 19/105,776

(22) PCT Filed: Jul. 4, 2023
(86) PCT No.: PCT/EP2023/068432

§ 371 Date: Feb. 21, 2025

(30) Foreign Application Priority Data
Sep. 6, 2022 (DE) 10 2022 209 269.4

(51) Int. Cl. B66F 3/46; B66F 5/00

(52) U.S. Cl. CPC B66F 3/46; B66F 5/00

(57) ABSTRACT

The present disclosure relates to a data transmission device for transmitting data between at least two lifting platforms 10 of a lifting system 100, and to a lifting system 100, in particular for lifting vehicles, comprising at least two lifting platforms 10, in particular at least two mobile lifting platforms.

The present disclosure relates to a data transmission device for transmitting data between at least two lifting platforms of a lifting system, in particular of a lifting system for lifting vehicles, and to a lifting system, in particular for lifting vehicles, comprising at least two lifting platforms, in particular at least two mobile lifting platforms.

So-called mobile column lifting platforms are mobile and rest on the wheels of a vehicle in order to lift it. As a result, these lifting platforms are very flexible and can be used for a wide variety of vehicle types. In order to lift a vehicle, individual lifting platforms can be interconnected to form a group (lifting system), which can then be controlled and monitored jointly. For this purpose, it is necessary to exchange data between a central controller and/or between the individual lifting platforms. This is preferably effected by radio in order to avoid obstructive cables in the working area of the vehicle.

Patent Literature 1 discloses a vehicle lifting system having a plurality of mobile lifting columns and a central control unit, which each comprise a wireless communication system for transmitting and receiving radio signals.

Patent Literature 1: US 2020/377354 A1

The radio frequency 2.4 GHz is preferably used for the radio connection, but is also used, for example, for WLAN radio networks. These frequently occur in workshops, since, for example, coaches are increasingly equipped with WLAN access points.

Therefore, despite highly developed radio technology, it can never be completely ruled out that interference in the radio connection between the individual lifting platforms can occur as a result of the influence of external radio networks. During such a radio interference, further operation of the lifting system is no longer possible and activity on a vehicle located thereon must be interrupted. Depending on the duration of the interruption, this can result in considerable damage to the workshop.

An object of the disclosed subject matter is to provide a data transmission device for a lifting system, in particular for a lifting system for lifting vehicles, which data transmission device allows interference-free data transmission at any time. A further object is to provide a lifting system comprising at least two lifting platforms, in particular at least two mobile lifting platforms, which has improved usability. The features of the independent claims are proposed to achieve the objects. Advantageous embodiments are found in the dependent claims.

In detail, a data transmission device for transmitting data between at least two lifting platforms (preferably mobile column lifting device or lifting column) of a lifting system is disclosed, which data transmission device comprises a control device for each lifting platform of the lifting system, which is configured to control the lifting system and has an input connection and an output connection.

The lifting system can preferably comprise a group of up to eight lifting platforms. A higher number of lifting platforms in the lifting system is likewise possible. The lifting system can be controlled by any desired control device of the grouped lifting platforms and/or by means of a separate control unit as central control unit.

The control device for a lifting platform can preferably comprise control electronics and a control panel into which control commands can be input. For example, a group of lifting platforms can be combined by means of the control device of a selected lifting platform (central control unit) to form a lifting system. Lifting devices of the lifting system can then be lifted and lowered jointly by means of corresponding buttons on the control panel of the control device of the selected lifting platform.

Furthermore, the control electronics of each control device can receive signals from a plurality of sensors (e.g. position sensors, displacement sensors, rotation sensors) which can be attached to each lifting platform and carry out control functions on the basis of the received signals. In particular, the central control unit can carry out safety functions, such as, for example, stopping of the lifting devices, on the basis of received sensor signals.

Furthermore, the data transmission device comprises a radio device for each lifting platform of the lifting system, which radio device is configured to transmit data of the control device by radio. In other words, the data transmission device has a transmitter/receiver for each lifting platform of the lifting system, by means of which transmitter/receiver signals of the respective control device can be transmitted (transmitted and received) wirelessly from one lifting platform to a further lifting platform of the lifting system. In addition, the individual lifting platforms can transmit signals to and/or receive signals from a central control unit by means of the radio device.

As already described above, the central control unit can be a separate control unit or a control device of a selected lifting platform, by means of which control device a plurality of lifting platforms have been combined to form a lifting system. The exchange of data between the individual lifting platforms of a lifting system makes it possible, for example, by means of the control electronics of the central control unit to provide synchronization control/regulation, that is to say to control/regulate drives of the individual lifting platforms of the lifting system in such a way that their lifting devices move at the same speed to the same height.

In addition, the data transmission device comprises at least one cable, which has an input plug and an output plug. In this case, the input plug of the cable can be connected to the input connection of the control device and the output plug can be connected to the output connection of the control device. This means that control devices of two adjacent lifting platforms can be connected to the cable by virtue of the output plug of the cable being plugged into the output connection of a first lifting platform and the input plug of the cable being plugged into the input connection of a second lifting platform. The cable can preferably have a length of 0.5 m to many meters. In particular, cables of different lengths can be present for connecting lifting platforms in lifting systems for different vehicles.

The cable has at least one line for providing a supply voltage for the lifting platform and at least one further line for transmitting data of the control device. In other words, a supply voltage of a first lifting platform can be provided at a second lifting platform by means of the cable. At the same time, data can be exchanged between two lifting platforms connected by means of the cable or between the control devices thereof by means of the at least one further line.

The data transmission device thus allows both wireless and wired data transmission between individual lifting platforms of a lifting system. In this way, data transmission is also possible if there is interference in the radio connection between the lifting platforms. The separation of the data line from the power line within the cable also allows a high data transmission rate and a stable data connection. In particular, the cable can also be laid or connected only in the event of interference in the radio network and can thus be used as a safety measure for further operation of a lifting platform.

The cable can preferably comprise at least two lines for providing a supply voltage and particularly preferably three lines for providing a supply voltage.

According to one embodiment, the cable can have at least two separate lines for transmitting data. In this case, both lines can be used both for transmitting and for receiving data. This allows flexible use of the two lines with regard to the data transmission, as a result of which the data transmission rate can be increased once again.

It goes without saying that the input and output plugs of the cable each have a number of contacts corresponding to the number of lines of the cable.

According to one embodiment, a first radio device can be arranged at an upper end of the lifting platform and a second radio device can be arranged at a lower end of the lifting platform. The terms “upper end” and “lower end” of the lifting platform“ in this case relate to the main direction of extent of the lifting platform in the vertical direction. The spatial coverage of the radio signal can be improved by using two radio devices at different positions of the lifting platform.

According to one embodiment, the input connection and the output connection of the control device can be designed to be secure against confusion. In particular, the input and the output connection can be designed in such a way that the output plug cannot be plugged into the input connection and the input plug cannot be plugged into the output connection. For example, the input connection can have plug contacts and the output connection can have contact sleeves. In this case, the input plug can contain contact sleeves which can be pushed onto the plug contacts of the input connection, while the output plug can contain plug contacts which can be plugged into the contact sleeves of the output connection. Alternatively or additionally, the input and output connection of the control device can have different geometries, for example different external geometries, to which the geometries of the respective plugs are adapted. Alternatively or additionally, it is also possible to provide color markings or visual markings.

According to one embodiment, the input connection and the output connection can be arranged at a lower end of a housing of the control device when the control device is mounted on a lifting platform. In particular, the input and output connection can be arranged on an underside of the control device. This means that the input and output connection are arranged outside the region of the control panel of the control device and thus do not obstruct access thereto. In addition, this position allows simple and space-saving attachment of the cable for connecting the control devices of two lifting platforms of the lifting system by means of the input and output plugs.

According to one embodiment, the data transmission device can also comprise a power cable which can be connected to the input connection of the control device. For this purpose, the power cable can comprise an input plug in particular on one side and a power plug on an opposite side. This means that at least one lifting platform can be supplied with power by means of the data transmission device in order, for example, to charge an energy store of the lifting platform. In order to charge all energy stores of the lifting platforms of the lifting system, a first lifting platform can be connected to a power voltage source by means of the power cable, and all other lifting platforms can each be connected to a cable. In this case, each lifting platform of the lifting system can function as first lifting platform, i.e. the power cable can be connected to any desired lifting platform of the lifting system. The power voltage source can preferably be a 230 V protective contact socket. In this case, the power plug can be a protective contact plug.

During the charging process of the energy stores, data can be transmitted between the control devices of the individual lifting platforms via the data lines of the cable. In this way, during the charging process of the energy stores, no current is consumed for data transmission by radio.

In addition, a lifting system, in particular for lifting vehicles, is disclosed, which lifting system comprises at least two lifting platforms, in particular at least two mobile lifting platforms. The mobile lifting platforms of the lifting system can particularly preferably be mobile column lifting platforms.

The lifting system can preferably comprise a group of up to eight lifting platforms. A higher number of lifting platforms in the lifting system is likewise possible. The lifting system can be controlled by any desired control device of the grouped lifting platforms and/or by means of a separate control unit as central control unit.

Each of the lifting platforms of the lifting system has a base device, a lifting column, a lifting device, a drive and a data transmission device as described above.

The base device of the lifting platform can be set up on a floor, i.e. the base device can be set up, for example, on the floor of a workshop or can rest thereon. The base device can have, for example, a carriage/a movable carriage with a base frame which can rest on the workshop floor after the lifting platform has been moved to the desired location by means of the carriage. Alternatively, the base device can also be designed as a carrier plate or mounting plate.

The lifting column is connected to the base device and a lifting device is arranged on the lifting column and can be moved along the lifting column by means of the drive. In other words, the drive can lift the lifting device relative to the lifting column and lower it again. The lifting device can preferably have a lifting carriage with a receiving fork. The drive can preferably be a spindle drive, but a hydraulic drive is likewise possible.

In order to provide energy for the drive, each lifting platform also comprises an energy storage. The energy storage can preferably be a rechargeable battery, particularly preferably a lithium-ion rechargeable battery. The energy storage can be contained in a control device of the lifting platform, i.e. be arranged within a housing of the control device.

Each lifting platform can furthermore contain a plurality of sensors, such as, for example, position sensors, displacement sensors, rotation sensors, etc. The signals of the sensors can be transmitted, for example, to control electronics of the central control unit of the lifting system and used for controlling the lifting devices of the individual lifting platforms or for carrying out safety functions.

An output connection of a control device of a first of the at least two lifting platforms of the lifting system can be connected to an input connection of a control device of a second lifting platform by means of a cable which has an input plug and an output plug. A supply voltage can be provided from the first to the second lifting platform by means of at least one line of the cable and, at the same time, data of the control device of the first lifting platform and data of the control device of the second lifting platform can be transmitted between the first and the second lifting platform by means of at least one further line of the cable. It goes without saying that the supply voltage can also be provided in the same way from the second lifting platform to the first lifting platform. In other words, the second/first lifting platform can be connected to the voltage supply of the first/second lifting platform via the cable and, at the same time, both lifting platforms or the control devices thereof can exchange data/communicate with one another via the cable. In this case, data is transmitted in the cable via a further data line which is separated from the power line, as a result of which a high data transmission rate and a stable data connection can be realized.

The terms “first lifting platform” and “second lifting platform” are intended to be understood in the sense of “one lifting platform” and “another lifting platform” and do not restrict the number of lifting platforms of the lifting system to two. Instead, the lifting system can preferably have up to eight lifting platforms, as already described above, wherein a higher number of lifting platforms is likewise possible.

According to one embodiment, the data transmission device can be configured to transmit data of the control device of the first lifting platform and data of the control device of the second lifting platform between the first and the second lifting platform by radio if there is no obstacle between a radio device of the first lifting platform and a radio device of the second lifting platform. In other words, at least one radio device (transmitter/receiver) of the data transmission device, such as, for example, at least one antenna, can be arranged at each lifting platform of the lifting system, by means of which radio device data can be exchanged between the control devices of the lifting platforms. Two antennas, of which one can be arranged at an upper end of the lifting column and one can be arranged in the region of the base device, can preferably be arranged at each lifting platform. Data transmission by radio can always take place if there is no obstacle between the radio devices of the individual lifting platforms. An obstacle is intended to be understood to mean all states/events which lead to an interruption of the radio connection, such as material obstacles but also interference signals.

If there is an obstacle between the radio device of the first lifting platform and the radio device of the second lifting platform, the data transmission device can be configured to transmit data of the control device of the first lifting platform and data of the control device of the second lifting platform between the first and the second lifting platform by means of the at least one further line of the cable. In this case, the control devices of two lifting platforms can thus be connected by means of the cable, so that data can be transmitted via the data line(s) of the cable. In particular, all lifting platforms of the lifting system can be connected to one another by a suitable number of cables. In this way, data transmission is also possible if there is interference in the radio connection between the lifting platforms.

According to one embodiment, an input connection of a control device of a lifting platform of the lifting system can be connected to a power voltage source by means of a power cable. The power voltage source can preferably be a 230 V protective contact socket. If all lifting platforms of a lifting system are connected by means of cables, as described above, they can be supplied with power from a power voltage source via the power cable and an input connection of an individual lifting platform. The cables between the individual lifting platforms can thus simultaneously serve as a power line and as a data line. For this purpose, they have separate lines for data transmission and for voltage supply.

### BRIEF DESCRIPTION OF THE FIGURES

FIG. 1 shows schematically a mobile column lifting platform which can be used in the present disclosure, in a three-dimensional illustration;

FIGS. 2a and 2b show a control device of the lifting platform illustrated in FIG. 1 in a three-dimensional illustration with an input and an output connection, and a cable with corresponding mating plugs for the input and output connections of the control device; and

FIG. 3 shows a lifting system according to an exemplary embodiment of the present disclosure in a plan view.

### DETAILED DESCRIPTION OF EXEMPLARY EMBODIMENTS

Exemplary embodiments of the present disclosure are described in detail below on the basis of exemplary figures. The features of the exemplary embodiments can be combined as a whole or in part and the present disclosure is not restricted to the exemplary embodiments described. In the figures, identical elements are provided with identical reference symbols, with the result that a repeated description of the elements is dispensed with if this is not necessary.

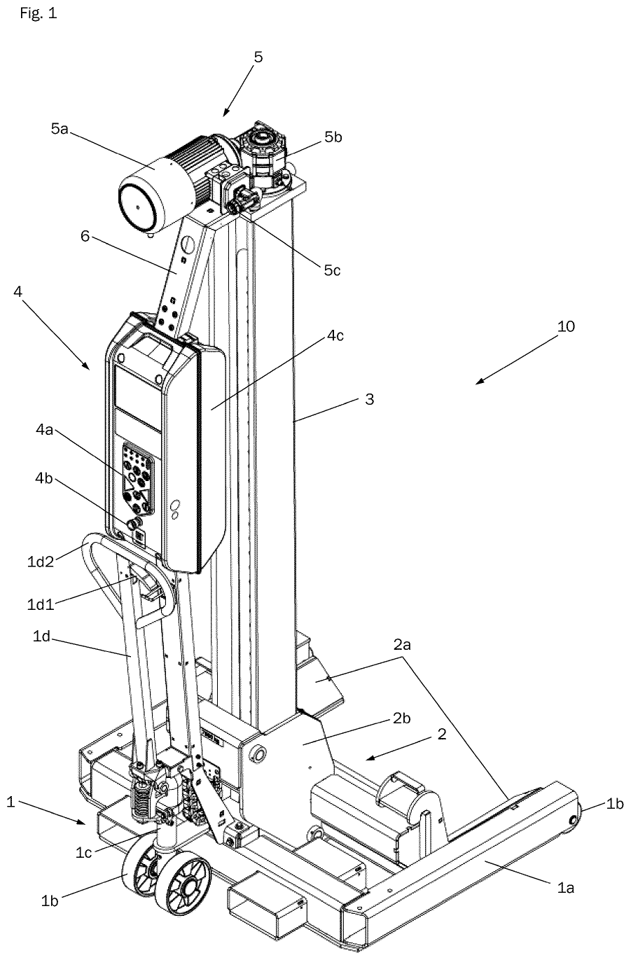

FIG. 1 shows schematically a mobile column lifting platform (here also lifting platform for short) 10 which can be used in the present disclosure, in a three-dimensional illustration. The mobile column lifting platform shown comprises a base device 1 in the form of a carriage 1, a lifting device 2, a lifting column 3, a control device 4 and a drive 5.

The carriage 1 has a base frame 1a, wheels 1b, a hydraulic cylinder 1c and a drawbar 1d with an operating lever 1d1 and a handle 1d2. In a stationary state of the lifting platform 10, the base frame 1a, which is in the form of a U-shaped frame construction in the exemplary embodiment shown, rests fixedly, for example on a floor of a workshop, and thus allows the lifting platform 10 to stand in a stable manner. In order to move the lifting platform in the workshop, the base frame 1a can be lifted from the floor of the workshop by means of the hydraulic cylinder 1c and can be moved to a desired location in the workshop by pulling/pushing on the handle 1d2 of the drawbar 1d on the wheels 1b. In order to lift the base frame 1a, the operating lever 1d1, which is attached to an upper end of the drawbar 1d in the exemplary embodiment illustrated, can be moved into a first position, as a result of which a hydraulic valve (not illustrated) is closed. If hydraulic fluid (not illustrated) is then pumped into the hydraulic cylinder 1c by an up and down movement (pumping movement) of the drawbar 1d, the latter lifts the base frame 1a. When the lifting platform 10 is placed at the desired location, the hydraulic valve can be opened by moving the operating lever 1d1 into a second position, with the result that the hydraulic fluid can flow out of the hydraulic cylinder 1c and the latter can lower the base frame 1a again onto the workshop floor.

The lifting column 3 is fastened to the base frame 1a of the carriage 1 in such a manner that it likewise stands fixedly on the workshop floor when the base frame 1a is completely lowered and rests on the workshop floor. In the exemplary embodiment shown, the lifting device 2 is designed as a lifting carriage 2 with a carriage guide 2b and a receiving fork 2a. In this case, the carriage guide 2b serves to move the lifting carriage 2 along the lifting column 3 in a defined manner and the receiving fork 2a serves to receive loads. For example, a wheel of a vehicle can be received/held by the receiving fork 2a.

In the exemplary embodiment illustrated, the drive 5 of the lifting carriage 2 is designed as a spindle drive. The latter can preferably comprise a motor 5a, which can be, in particular, an electric motor 5a, a transmission 5b and a lifting spindle (not illustrated). An electrical connection 5c, to which a connecting cable (not illustrated) to an energy storage (not illustrated) can be connected, is provided on the electric motor 5a illustrated. The lifting spindle can be arranged in the lifting column 3 and can be in engagement with a supporting nut (not illustrated) which is connected to the lifting carriage 2. By rotating the lifting spindle by means of the motor 5a and the transmission 5b, the lifting carriage 2 fastened to the supporting nut can be moved in the vertical direction along the lifting column 2. It is likewise possible for the lifting carriage 2 to be moved by means of a hydraulic drive.

In order to control the drive 5, the control device 4 is provided on the lifting platform 10. The control device 4 shown comprises a control panel 4a and an emergency switch 4b, which are attached to a housing 4c of the control device or are integrated therein. Control electronics and an energy storage (not illustrated) are located in the interior of the housing 4c. The control device 4 is attached to a two-part carrier 6, the upper part of which is connected to the lifting column 3 on one side and to an upper side of the housing 4c of the control device 4 on another side. The lower part of the carrier 6 is in turn connected to the base frame 1a of the carriage 1 on one side and to an underside of the housing 4c on another side.

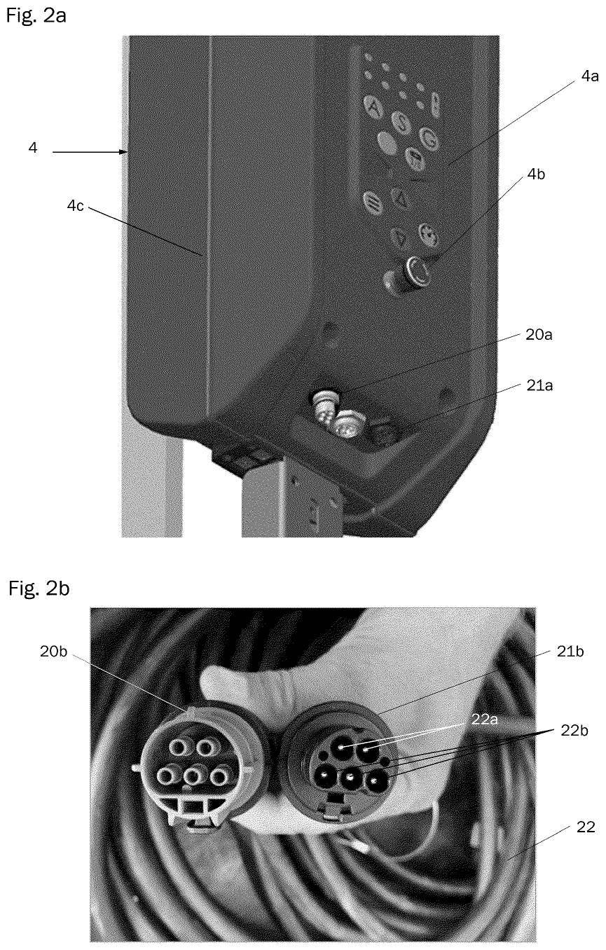

An input connection 20a and an output connection 21a, which are described in more detail below in conjunction with FIG. 2a, are also attached to the underside of the housing 4c of the control device 4. By means of these connections, control devices 4 of lifting platforms 10 of a lifting system 100 can be connected to one another via a cable 22, which is described in more detail in conjunction with FIG. 2b. In this case, the cable 22 can be used both for communication between the respective control devices 4 and for voltage supply of the lifting platforms 10.

In addition, a first radio device (not illustrated), which can preferably be an antenna, for wireless communication between the individual lifting platforms 10 of the lifting system 100 is attached to an upper end of the lifting platform 10. In addition, data can be transmitted to a central control unit of the lifting system 100 by means of the radio connection. Two antennas (first and second radio device), of which one can be arranged at an upper end of the lifting column 3 and one can be arranged in the region of the base device 1, can preferably be arranged at each lifting platform. The central control unit can be a separate control unit or a control device 4 of a selected lifting platform 10, by means of which control device a plurality of lifting platforms 10 have been combined to form a lifting system 100. The lifting platform 10 shown thus offers the possibility of transmitting data of its control device 4 both wirelessly and wired.

FIG. 2 a shows schematically a control device 4 of the lifting platform illustrated in FIG. 1 in a three-dimensional illustration. In this illustration, the input connection 20a and the output connection 21a, which serve to connect the control devices 4 of two adjacent lifting platforms 10, are visible on the underside of the housing 4c of the control device 4. In the exemplary embodiment shown, the input and output connections 20a, 21a each comprise five contacts, of which two serve to connect the data line 22a and three serve to connect the supply voltage lines 22b of the cable 22. It becomes clear that, as a result of the attachment of the input and output connections 20a, 21a on the underside of the housing 4c of the control device 4, simple and space-saving attachment of the cable 22 for connecting the control devices 4 of two lifting platforms 10 by means of the input and output plugs 20b, 21b is possible.

In addition, the control panel 4a of the control device 4, which has pushbuttons via which control commands can be input into the control device 4, can be readily seen in FIG. 2. For example, a group of lifting platforms 10 can be combined to form a lifting system 100 via the control panel 4a of a control device 4. In this case, this control device 4 becomes the central control unit with which the lifting devices 2 of the lifting system 100 can be lifted and lowered jointly by means of the corresponding buttons on the control panel 4a. The emergency stop switch 4b, with which the lifting system 100 can be switched off by an operator, for example in a safety-critical malfunction, is attached below the control panel 4a.

FIG. 2b shows schematically a cable 22 with corresponding mating plugs 20b, 21b for the input and output connections 20a, 21a of the control device shown in FIG. 2a. The cable 22 can preferably have a length of a plurality of meters or a suitable length for connecting a plurality of lifting platforms 10. In particular, cables 22 of different lengths can be present for connecting lifting platforms 10 in lifting systems 100 for different vehicles. Corresponding to the input and output connections 20a, 21a of the control device 4, the input plug 20b and the output plug 21b have five contacts, wherein the two upper contacts 22a connect the data lines and the three lower contacts 22b connect the power lines. In the exemplary embodiment illustrated, the input plug 20b has contact sleeves and the output plug 21b has plug contacts. This ensures that the respective plug 20b, 21b is connected to the correct connection 20a, 21a of the control device 4.

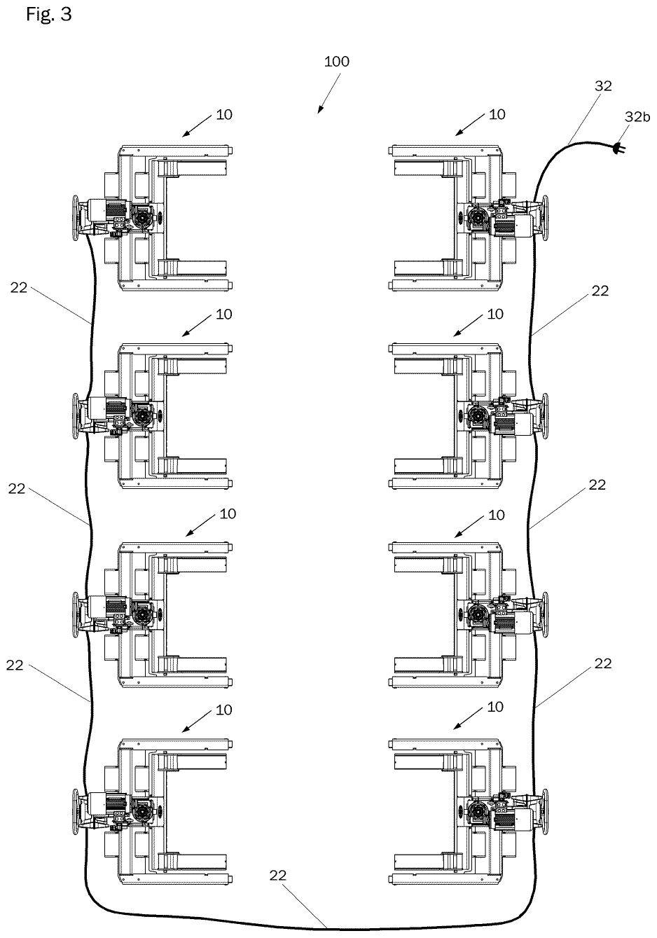

FIG. 3 shows schematically a lifting system 100 according to an exemplary embodiment of the present disclosure in a plan view, which comprises eight of the mobile column lifting platforms 10 shown in FIG. 1. The lifting system 100 can be connected to a power voltage source (not illustrated) by means of a power cable 32 having a power plug 32b. The individual lifting platforms 10 of the lifting system 100 can be supplied with a power by means of the cables 22, which power can be used to charge the energy stores of the lifting platforms 10. In addition, data can be transmitted between the control devices 4 of the lifting platforms 10 by means of the cables 22. Operation of the lifting system 100 is thus also possible if the radio connection between the lifting platforms 10 is interfered with.

1. Data transmission device for transmitting data between at least two lifting platforms of a lifting system, comprising
a control device for each lifting platform of the lifting system which is configured to control the lifting system and has an input connection and an output connection
at least one radio device for each lifting platform of the lifting system, which is configured to transmit data of the control device by radio; and
at least one cable, which has an input plug and an output plug, wherein
the input plug can be connected to the input connection and the output plug can be connected to the output connection of the control device, and wherein the cable has at least one line for providing a supply voltage for the lifting platform and at least one further line for transmitting data of the control device.

2. Data transmission device according to claim 1, wherein the cable has at least two separate lines for transmitting data.

3. Data transmission device according to claim 1, wherein a first radio device is arranged at an upper end of the lifting platform and a second radio device is arranged at a lower end of the lifting platform.

4. Data transmission device according to claim 1, wherein the input connection and the output connection of the control device are designed to be secure against confusion.

5. Data transmission device according to claim 1, wherein the input connection and the output connection are arranged at a lower end of a housing of the control device when the control device is mounted on a lifting platform.

6. Data transmission device according to claim 1, further comprising a power cable which can be connected to the input connection of the control device.

7. Lifting system, in particular for lifting vehicles, comprising at least two lifting platforms, in particular at least two mobile lifting platforms, wherein each lifting platform has the following:
a base device , by means of which the lifting platform can be set up on a floor;
a lifting column which is connected to the base device;
a lifting device which is arranged on the lifting column and can be moved along the lifting column;
a drive which is configured to drive the lifting device;
an energy storage which is configured to provide energy for the drive of the lifting platform; and
a data transmission device according to claim 1, wherein
an output connection of a control device of a first of the at least two lifting platforms can be connected to an input connection of a control device of a second lifting platform by means of a cable which has an input plug and an output plug, and wherein
a supply voltage can be provided by means of at least one line of the cable from the first to the second lifting platform, and
data of the control device of the first lifting platform and data of the control device of the second lifting platform can be transmitted between the first and the second lifting platform by means of at least one further line of the cable

8. Lifting system according to claim 7, wherein
the data transmission device of each lifting platform is configured to transmit data of the control device of the first lifting platform and data of the control device of the second lifting platform between the first and the second lifting platform by radio if there is no obstacle between a radio device of the first lifting platform and a radio device of the second lifting platform, and
data of the control device of the first lifting platform and data of the control device of the second lifting platform can be transmitted between the first and the second lifting platform by means of the at least one further line of the cable if there is an obstacle between the radio device of the first lifting platform and the radio device of the second lifting platform.

9. Lifting system according to claim 7, wherein at least one input connection of a control device of a lifting platform of the lifting system is connected to a power voltage source by means of a power cable.
